(19) United States
(12) Patent Application Publication
(10) Pub. No.: US 2022/0114370 A1
(43) Pub. Date: Apr. 14, 2022

(54) VISION SYSTEM FOR DETECTING OBJECTS IN A SWING PATH

(71) Applicant: Magna Electronics Inc., Auburn Hills, MI (US)

(72) Inventor: Jaidev Khatri, Rochester Hills, MI (US)

(21) Appl. No.: 17/450,089

(22) Filed: Oct. 6, 2021

Related U.S. Application Data
(60) Provisional application No. 63/198,334, filed on Oct. 12, 2020.

(51) Int. Cl. G06K 9/00; G08B 21/02; G08B 7/06; G06T 7/20; H04N 7/18; A63G 9/22

(52) U.S. Cl. CPC G06K 9/00771; G08B 21/02; G08B 7/06; G06T 7/20; G06K 9/00362; G06T 2207/30232; A63G 9/22; G06T 2207/30241; G06T 2207/30196; G06K 9/00791; H04N 7/18

(57) ABSTRACT

A vision system includes a camera viewing at least part of a swing path of a swing, the camera capturing image data. An electronic control unit (ECU) includes an image processor for processing image data captured by the camera to detect presence of objects in the field of view of the camera. The system, responsive to processing by the image processor of image data captured by the camera, and with the swing having an occupant swinging along a swing path of the swing, detects presence of an object that has a potential to collide with the occupant of the swing. The system, responsive to detecting the presence of the object that has the potential to collide with the occupant of the swing, generates an alert and/or engages an arrester to slow the swing as the swing travels along the swing path.

### CROSS REFERENCE TO RELATED APPLICATION

The present application claims the filing benefits of U.S. provisional application Ser. No. 63/198,334, filed Oct. 12, 2020, which is hereby incorporated herein by reference in its entirety.

### FIELD OF THE INVENTION

The present invention relates generally to a vision system and, more particularly, to a vision system that utilizes one or more cameras.

### BACKGROUND OF THE INVENTION

Typical playground equipment, such as swings, commonly cause injuries. For example, when an object (such as another person) enters a swing path of a swing, a collision may occur that may cause injuries.

### SUMMARY OF THE INVENTION

Implementations herein provide a vision system or imaging system for playground equipment that utilizes one or more cameras (preferably one or more CMOS cameras) to capture image data representative of images at or near the playground equipment. The camera may be disposed at the playground so as to view a swing, and views at least part of a swing path of the swing and captures image data. The swing contains an occupant swinging along the swing path of the swing. The system includes a control with electronic circuitry and associated software. The electronic circuitry of the control includes an image processor for processing image data captured by the camera to detect presence of objects in or approaching the swing path of the camera. The control, responsive to processing by the image processor of image data captured by the camera, detects presence of an object that has a potential to collide with an occupant of the swing. The control, responsive to detecting the presence of the object that has the potential to collide with the occupant of the swing, may generate an alert (such as an audible alert) to alert the person on the swing or the person moving toward the swing path of the potential hazard or may engage an arrester to slow the swing as the swing travels along the swing path.

These and other objects, advantages, purposes and features of the present invention will become apparent upon review of the following specification in conjunction with the drawings.

### BRIEF DESCRIPTION OF THE DRAWINGS

FIG. 1 is a front plan view of playground vision system that incorporates cameras; and

FIG. 2 is a side plan view of the playground vision system of FIG. 1.

### DESCRIPTION OF THE PREFERRED EMBODIMENTS

A vision system and/or object detection system operates to capture images and may process the captured image data to detect objects, such as to predict potential collisions between objects. The vision system includes an image processor or image processing system that is operable to receive image data from one or more cameras process the image data for object detection.

Implementations herein describe a vision system for playground equipment and/or for a playground, park, or other recreation area. For example, the vision system may be included with a swing set. When swinging on a swing, there is a chance of injury or damage when objects enter the swing path of the person swinging. For example, when another child enters the swing path of the swing, both the child and the person swinging may be injured due to the collision.

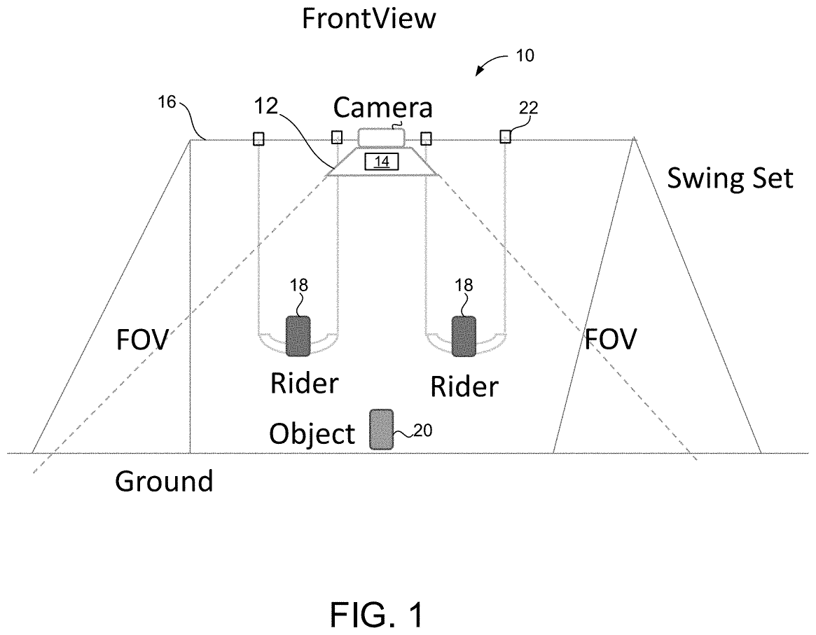

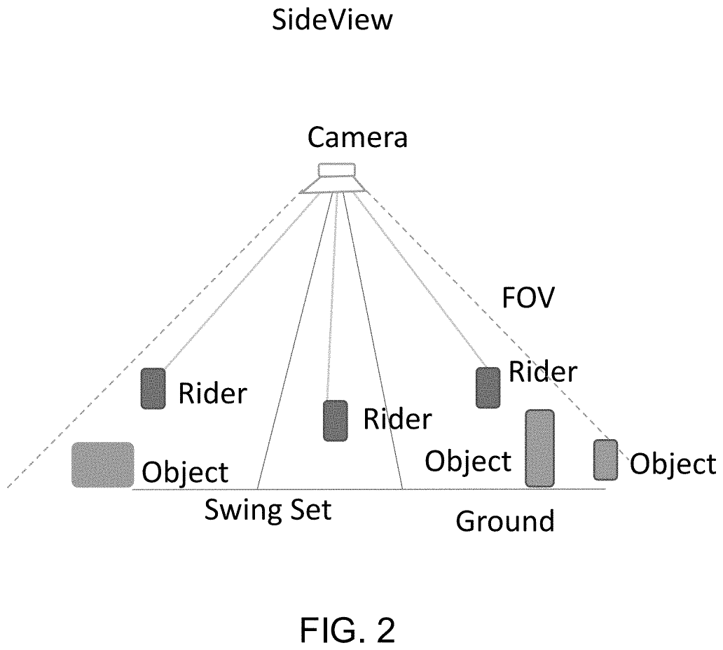

Referring now to FIGS. 1 and 2, a vision system 10 includes at least one image sensor 12, such as a camera. The system includes a control or electronic control unit (ECU) 14 (e.g., a control or ECU having electronic circuitry that includes an image and/or data processor) that processes image data captured by the image sensor 12. The control may be disposed at or within the image sensor 12 or separate from the image sensor 12. The image sensor may be mounted above a swing 16 (such as at a cross-bar that supports the swing) and have a downward field of view that encompasses the swing path of riders 18 of the swings and a portion of the surrounding area. Optionally, the image sensor or camera may be disposed at a side support of the swing or elsewhere on the swing or remote from the swing, with the camera viewing the swing path region.

The control, using the image data captured by the image sensor, detects presence of one or more objects 20 within the field of view of the image sensor. The control may determine the presence of objects that are within the swing path (i.e., the angular or arcuate path of the swing) of one or more swings. The control may also predict that an object that is not currently within the swing path is on a trajectory that will eventually place the object within the swing path. The control may also detect presence of objects that are not within the swing path of the swing, but that are within a threshold distance of the swing and are thus at risk of entering the swing path. For example, the detected object may be another person (e.g., a child) or animal (e.g., a dog) entering a swing path from outside the view of the camera. The detected object may also be a rider of a swing that has left a swing or fallen off a swing into the swing path of another swing.

When the control determines that a detected object poses a potential collision risk with a rider of a swing (e.g., the detected object is within the swing path, is near the swing path, and/or is on a trajectory that intersects with the swing path), the control slows or halts the swing to avoid or mitigate or lessen the potential collision. For example, the control may enable one or more arresters 22. The arrester may be disposed at a pivot point of the swing for one or more connection points between the swing and the supporting structure. The arrester may halt or slow the pivot of the swing (e.g., by applying force and slowing the swing via friction). The control may determine an amount of force for the arrester to apply based on a current velocity of the swing and/or an amount of time until the swing collides with the detected object. The control may determine a maximum amount of force that may be applied without risking harm to the swing rider based on, for example, the current speed of the occupant of the swing.

Optionally, the system may generate an alert (such as a visible or audible alert) to alert the person on the swing or the person moving toward the swing path of the potential hazard. Thus, if a person is walking near the swing and is approaching the swing path, the system may alert the pedestrian so the pedestrian is aware of the swing path and potential hazard. For example, the system may play a warning sound and/or flash a light.

Thus, the vision system described herein provides a safer swing proximity and increased rider safety by detecting objects that enter the field of view of a camera that at least partially includes a swing path of a swing. When the system determines a possibility of a collision between a rider of the swing and a detected object, the system slows or halts the swing to mitigate the collision (e.g., using one or more actuators).

Optionally, the system may be applicable to other forms of playground equipment. For example, a camera may monitor spinning playground equipment (e.g., a “merry-go-round”) and arrest or slow the equipment based on detected conditions. In another example, the camera may monitor a “teeter-totter” (or “seesaw”) and slow the descent/ascent based on detected objects (e.g., when a child goes under a teeter-totter or one person jumps off the teeter-totter, causing the other side to rapidly descend).

The camera (or other image sensor) may be installed in a variety of locations. For example, the camera may be disposed at the swing set itself (such as at the horizontal cross bar or at one of the side supports of the bar). The camera may also be mounted nearby, such as at a tree or pole. Optionally, the camera may be a part of another system. For example, the camera may be part of a playground surveillance system that monitors activity at the playground (where image data captured by the camera may be stored and/or processed for a variety of applications). Optionally, the swing control system may utilize image data captured by other cameras in the vicinity of the playground (and that may wirelessly transmit captured image data to the swing control system). For example, the camera may be disposed at a vehicle as part of a vehicular vision system (e.g., for a driver assistance system), and when the vehicle is parked within view of the swing, the camera or vehicular vision system may capture image data and wirelessly communicate the captured image data to the swing control, or optionally, the vehicular vision system may process the captured image data to detect objects in the swing path and may wirelessly communicate the detection of objects to the swing control or to the arrester.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect objects.

Changes and modifications in the specifically described embodiments can be carried out without departing from the principles of the invention, which is intended to be limited only by the scope of the appended claims, as interpreted according to the principles of patent law including the doctrine of equivalents.

1. A vision system, the vision system comprising:
a camera viewing at least part of a swing path of a swing, the camera capturing image data;
an electronic control unit (ECU) comprising electronic circuitry and associated software;
wherein the electronic circuitry of the ECU comprises an image processor for processing image data captured by the camera to detect presence of objects in the view of the camera;
wherein the vision system, responsive to processing by the image processor of image data captured by the camera, and with the swing having an occupant swinging on the swing along the swing path, detects presence of an object that one selected from the group consisting of (i) is in the swing path and (ii) has a trajectory that intersects the swing path; and
wherein the vision system, responsive to detecting the presence of the object that one selected from the group consisting of (i) is in the swing path and (ii) has the trajectory that intersects the swing path, engages an arrester to slow the swing as the swing travels along the swing path or generates an alert.

2. The vision system of claim 1, wherein the camera is disposed above the swing.

3. The vision system of claim 1, wherein the vision system engages the arrester responsive to determination that the detected object is within the swing path of the swing.

4. The vision system of claim 1, wherein the vision system engages the arrester responsive to determination that a likelihood that the detected object is moving along the trajectory that intersects with the swing path of the swing is greater than a threshold likelihood.

5. The vision system of claim 1, wherein the vision system engages the arrester responsive to determination that the detected object is within a threshold distance of the swing path of the swing.

6. The vision system of claim 1, wherein the vision system, responsive to processing by the image processor of image data captured by the camera, determines a speed of the swing as the swing travels along the swing path, and wherein the vision system, determines an amount the arrester slows the swing at least in part based on the determined speed of the swing.

7. The vision system of claim 1, wherein the vision system, responsive to processing by the image processor of image data captured by the camera, determines a speed of the detected object, and wherein the vision system, determines an amount the arrester slows the swing at least in part based on the determined speed of the detected object.

8. The vision system of claim 1, wherein the arrester is disposed at a pivot point of the swing.

9. The vision system of claim 1, wherein the detected object is a pedestrian moving toward the swing path and wherein the vision system, responsive to detecting the presence of the pedestrian that one selected from the group consisting of (i) is in the swing path and (ii) has the trajectory that intersects the swing path, generates an alert to alert the pedestrian.

10. The vision system of claim 1, wherein the camera is disposed remote from the swing and wirelessly communicates with the vision system.

11. The vision system of claim 10, wherein the camera is disposed at a vehicle that is parked near the swing.

12. The vision system of claim 1, wherein the camera and the vision system are disposed remote from the swing and wirelessly communicates with the arrester.

13. The vision system of claim 12, wherein the camera and the vision system are part of a vehicular system disposed at a vehicle that is parked near the swing.

14. A vision system, the vision system comprising:
a camera viewing at least part of a swing path of a swing, the camera capturing image data;
an electronic control unit (ECU) comprising electronic circuitry and associated software;
wherein the electronic circuitry of the ECU comprises an image processor for processing image data captured by the camera to detect presence of objects in the view of the camera;
wherein the vision system, responsive to processing by the image processor of image data captured by the camera, and with the swing having an occupant swinging on the swing along the swing path, detects presence of a person that one selected from the group consisting of (i) is in the swing path and (ii) has a trajectory that intersects the swing path; and
wherein the vision system, responsive to detecting the presence of the person that one selected from the group consisting of (i) is in the swing path and (ii) has the trajectory that intersects the swing path, generates an alert, wherein the alert comprises an audible alert and a visual alert.

15. The vision system of claim 14, wherein the camera is disposed above the swing.

16. The vision system of claim 14, wherein the vision system generates the alert responsive to determination that the detected person is within the swing path of the swing.

17. The vision system of claim 14, wherein the vision system generates the alert responsive to determination that a likelihood that the detected person is moving along the trajectory that intersects with the swing path of the swing is greater than a threshold likelihood.

18. A vision system, the vision system comprising:
a camera viewing at least part of a swing path of a swing, the camera capturing image data;
an electronic control unit (ECU) comprising electronic circuitry and associated software;
wherein the electronic circuitry of the ECU comprises an image processor for processing image data captured by the camera to detect presence of objects in the view of the camera;
wherein the vision system, responsive to processing by the image processor of image data captured by the camera, and with the swing having an occupant swinging on the swing along the swing path, detects presence of an object that one selected from the group consisting of (i) is in the swing path and (ii) has a trajectory that intersects the swing path; and
wherein the vision system, responsive to detecting the presence of the object that one selected from the group consisting of (i) is in the swing path and (ii) has the trajectory that intersects the swing path, engages an arrester to slow the swing as the swing travels along the swing path and generates an alert.

19. The vision system of claim 18, wherein the vision system engages the arrester and generates the alert responsive to determination that the detected object is within a threshold distance of the swing path of the swing.

20. The vision system of claim 18, wherein the arrester is disposed at a pivot point of the swing.
